(19) United States
(12) Patent Application Publication
(10) Pub. No.: US 2025/0291177 A1
(43) Pub. Date: Sep. 18, 2025

(54) OPTICAL DEFLECTOR, SCANNING OPTICAL DEVICE, AND IMAGE FORMING APPARATUS

(71) Applicant: Konica Minolta, Inc., Tokyo (JP)

(72) Inventors: Akira TANIYAMA, Tokyo (JP); Ryo HASEGAWA, Tokyo (JP); Takahiro MATSUO, Tokyo (JP); Ema MOCHIZUKI, Tokyo (JP)

(21) Appl. No.: 19/076,783

(22) Filed: Mar. 11, 2025

(30) Foreign Application Priority Data
Mar. 14, 2024 (JP) 2024-039802

(51) Int. Cl. G02B 26/10; G02B 26/12; G03G 15/043

(52) U.S. Cl. CPC G02B 26/105; G02B 26/12; G03G 15/0435

(57) ABSTRACT

An optical deflector includes a housing, a rotary polygon mirror housed in the housing and having a mirror surface formed on an outer peripheral surface of the rotary polygon mirror, a substrate on which at least a part of a driving source configured to drive the rotary polygon mirror is mounted, a heat dissipation member that dissipates heat of the substrate to the outside, a heat transfer member includes an elastic body, is interposed between the substrate and the heat dissipation member, and transfer heat of the substrate to the heat dissipation member, fixing members that fix the substrate to the housing, and elastic members which elastically press the heat dissipation member and the heat transfer member against the substrate with a biasing force weaker than a fixing force of the fixing members such that the heat dissipation member and the heat transfer member are supported by the substrate.

### CROSS REFERENCE TO RELATED APPLICATIONS

The present invention claims priority under 35 U.S.C. § 119 to Japanese Patent Application Number 2024-039802, filed Mar. 14, 2024, the entire content of which is incorporated herein by reference.

### BACKGROUND OF THE INVENTION

### Technical Field

The present invention relates to an optical deflector, a scanning optical device, and an image forming apparatus.

### Description of Related Art

The image forming apparatus is a printer, a copier, or the like. An image is electrostatically formed on a photoreceptor in an image forming apparatus. As a forming means, a rotary polygon mirror is used. The rotary polygon mirror has a regular polygonal prism. The side surface of the regular polygonal prism is a mirror surface. The rotary polygon mirror is rotationally driven at a high speed by an electromagnetic force. The rotary polygon mirror reflects a light beam from a light source such as a semiconductor laser. The rotary polygon mirror deflects and scans the photoreceptor by the optical deflector. An electrostatic latent image is thus optically written onto the charged photoreceptor.

The rotary polygon mirror rotates at a high speed. The one having a high speed rotates at a high speed of about 58000 rpm. In an image forming apparatus using such a rotary polygon mirror, power consumption and heat generation of the substrate are increased due to high-speed rotational driving of the rotary polygon mirror. Therefore, a temperature increase may be a problem. In this case, a substrate is a board on which circuits of a power supply system and a control system are mounted. The circuits of the power supply system and the control system drive and control the driving source. Due to this temperature increase, the rotary polygon mirror and a scanning lens thermally expand. As a result, the positions and shapes of the components of the optical deflector change from the positions and shapes of the components at the time of assembly and adjustment of the optical deflector. This fluctuation may deteriorate the optical performance of the optical deflector. The deterioration includes a fluctuation in an image forming position of light and a fluctuation in a light beam diameter. Further, an adhesive used for bonding components of the optical deflector is subjected to a centrifugal force at a high temperature. As a result, the adhesive undergoes creep deformation. As a result, the optical scanning performance may deteriorate from the time of the initial adjustment. When such deformation increases, the rotation posture of the rotary polygon mirror collapses. Then, the driving source may be damaged. The driving source is a polygon motor.

There is a technique for preventing the above-described temperature increase in the optical deflector using the rotary polygon mirror. As a technique for preventing this, Japanese Unexamined Patent Publication Number 2013-113982 (hereinafter “Patent Literature 1”) can be cited. In Patent Literature 1, a heat dissipation member is used. Furthermore, a heat transfer member is sandwiched between the substrate and the heat dissipation member. Thus, heat generated in the substrate is released to the heat dissipation plate. In addition, heat dissipation is intended to be efficiently performed. The heat dissipation member is a heat dissipation plate. The heat transfer member is a heat conductive sheet.

However, in Patent Literature 1, the substrate is fastened to the heat dissipation plate with ordinary screws. In addition, there is no disclosure of a technology related to prevention of deformation of the substrate. Therefore, there have been disadvantages that deformation of the substrate, non-generation of a predetermined driving force, and inhibition of rotation of a polygon motor which is a driving source are feared.

### SUMMARY OF THE INVENTION

It is an object of the present invention to provide an optical deflector, a scanning optical device, and an image forming apparatus in which movement of a driving source for a rotary polygon mirror is less likely to be inhibited.

To achieve at least one of the abovementioned objects, according to an aspect of the present invention, an optical deflector reflecting one aspect of the present invention includes a housing, a rotary polygon mirror that is housed in the housing and has a mirror surface formed on an outer peripheral surface of the rotary polygon mirror, a substrate on which at least a part of a driving source to drive the rotary polygon mirror is mounted, a heat dissipation member that dissipates heat of the substrate to the outside, a heat transfer member that includes an elastic body, is interposed between the substrate and the heat dissipation member, and transfers heat of the substrate to the heat dissipation member, fixing members that fasten and fix the substrate to the housing, and elastic members that elastically presses the heat dissipation member and the heat transfer member against the substrate with a biasing force weaker than a fastening and fixing force of the fixing members such that the heat dissipation member and the heat transfer member are supported by the substrate.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view of an image forming apparatus main body of the image forming apparatus according to the present embodiment.

FIG. 2 is a schematic plan view of the inside of a scanning optical device in the image forming apparatus according to the present embodiment.

FIG. 3 is a schematic configurational view of a cutting place taken along a line A-A in FIG. 2. This schematic configuration diagram illustrates the inside of the scanning optical device.

FIG. 4 is a perspective view of a heat dissipation member of the image forming apparatus according to the present embodiment.

FIG. 5 is a perspective view of a heat transfer member of the image forming apparatus according to the present embodiment.

FIG. 6 is a perspective view of a heat transfer member of the image forming apparatus according to the present embodiment.

FIG. 7 is a perspective view of a coil of a driving source in the image forming apparatus according to the present embodiment.

FIG. 8 is a perspective view of a magnet and the like of a driving source in the image forming apparatus according to the present embodiment.

FIG. 9 is a conceptual cross-sectional view of a support structure for a heat dissipation member, a substrate, and the like in the image forming apparatus according to the present embodiment.

FIG. 10 is a perspective view illustrating another example of an elastic member in the image forming apparatus according to the present embodiment.

FIG. 11 is a plan view of a heat dissipation member of the image forming apparatus according to the present embodiment.

FIG. 12 is a vertical cross-sectional view conceptually illustrating a force applied to a substrate of the image forming apparatus according to the present embodiment.

FIG. 13 is an enlarged plan view of a part of the sealing material and a part of the casing in the image forming apparatus according to the present embodiment.

FIG. 14 is an enlarged plan view of part of a heat dissipation member in the image forming apparatus according to the present embodiment.

FIG. 15 is a conceptual cross-sectional view showing a modification example of the support structure for the heat dissipation member, the substrate, and the like in the image forming apparatus according to the present embodiment.

FIG. 16 is a longitudinal cross-sectional view conceptually illustrating simulation of a support structure for a heat dissipation member, a substrate, and the like of an image forming apparatus according to the present example.

FIG. 17 is a contour diagram of a simulation result for a support structure for a heat dissipation member, a substrate, and the like in the image forming apparatus according to the present example.

FIG. 18 is a contour diagram of a simulation result for a support structure for a heat dissipation member, a substrate, and the like in the image forming apparatus according to the present example.

FIG. 19 is a contour diagram of a simulation result for the support structure for the heat dissipation member, the substrate, and the like in the image forming apparatus according to the present embodiment.

### DETAILED DESCRIPTION

Hereinafter, one or more embodiments of the present invention will be described with reference to the drawings. However, the scope of the invention is not limited to the disclosed embodiments.

The following is a description of one embodiment of the invention. Note that the following embodiment is merely an example. The following embodiment does not limit the present invention. Within the scope of the present invention, the present invention is implemented in various forms. First, a problem of the present embodiment will be described. In Patent Literature 1, the substrate and the heat dissipation member sandwich the heat transfer member, and the substrate is fastened to the heat dissipation member with screws. Furthermore, there is no description on prevention of deformation of the substrate. Therefore, pressure caused by the pressing force of the screw is transmitted to the substrate via the heat transfer member. Therefore, there is a risk of substrate deformation. Due to this deformation, in a polygon motor which is a driving source of the rotary polygon mirror, a distance between a coil and a magnet changes from a predetermined distance. Then, in the driving source, an electromagnetic force which is an appropriate driving force is not generated, and the rotation performance of the rotary polygon mirror deteriorates. Alternatively, the rotary polygon mirror may not rotate at all. In this regard, in experiments and studies by the present inventors, it has been confirmed that the rotary polygon mirror does not rotate even when the heat transfer member is compressed by 0.1 mm.

The thicknesses of the heat transfer members are, for example, about 1 mm±0.2 mm. Thus, the tolerance is large. Therefore, it is also difficult to sandwich a spacer having a predetermined thickness. It is also conceivable to use the heat transfer member itself as a spacer. However, the Young's modulus of the heat transfer member is about several MPa. Thus, the heat transfer member is soft. Therefore, the heat transfer member is greatly compressed even by a force that holds the substrate or the heat dissipation member. Therefore, the substrate is also deformed by the pressure due to the pressing force of the screw. Therefore, even in this case, the same problem occurs.

A description of the configuration that has solved these problems in the present embodiment, and effects is as follows.

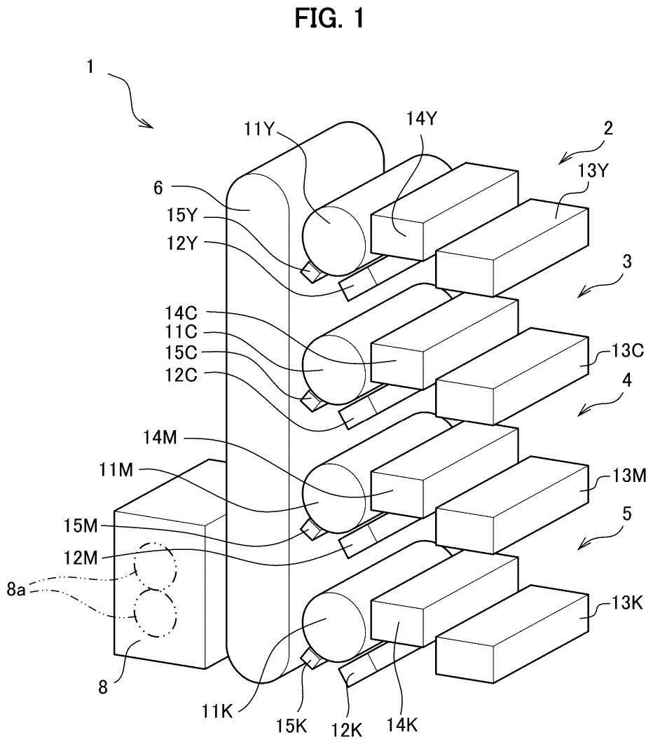

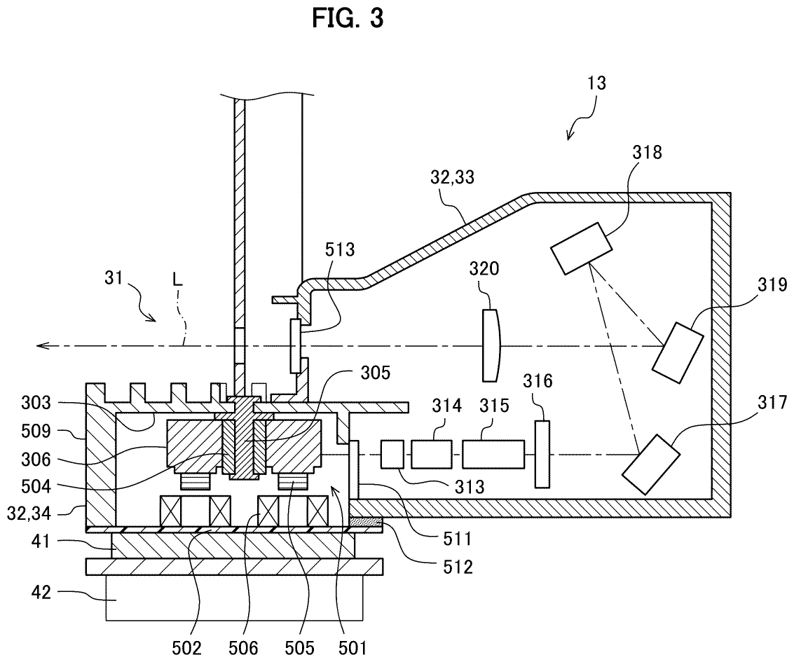

FIG. 1 is a perspective view of an image forming apparatus main body of the image forming apparatus according to the present embodiment. In FIG. 3, the image forming apparatus main body is housed in a housing 32. For example, an image forming apparatus main body of the image forming apparatus 1 includes a first transfer belt 6, a fixing device 8, and four image forming sections 2 to 5. Four image forming sections 2 to 5 are disposed in a vertical line.

The image forming sections 2 to 5 form toner images in corresponding different colors on corresponding photoreceptors, that is, photosensitive drums. For example, the different colors are yellow, cyan, magenta, and black. The photoreceptors are photoreceptors 11Y, 11C, 11M, and 11K. Yellow is represented by Y. Cyan is represented by C. Magenta is represented by M. Black is represented by K.

In the present example, the image forming section 2 forms a yellow toner image on the photoreceptor 11Y. The image forming section 3 forms a cyan toner image on the photoreceptor 11C. The image forming section 4 forms a magenta toner image on the photoreceptor 11M. The image forming section 5 forms a black toner image on the photoreceptor 11K. Note that in the present example, the number of image forming sections is four. Therefore, image formation with toner of four colors is possible. However, the image forming apparatus 1 may use toner in five or more colors. Alternatively, the image forming apparatus 1 may use toner of only one color. Yellow is represented by Y. Cyan is represented by C. Magenta is represented by M. Black is represented by K.

The image forming section 2 includes a charging device 12Y and a scanning optical device 13Y. The charging device 12Y charges the photoreceptor 11Y. The scanning optical device 13Y optically writes the electrostatic latent image on the photoreceptor 11Y. Furthermore, the image forming section 2 includes a developing device 14Y. The developing device 14Y develops the electrostatic latent images on the photoreceptor 11Y with yellow toner. The image forming section 2 also includes a discharging device 15Y. The discharging device 15Y discharges the photoreceptor 11Y. These devices are provided around the photoreceptor 11Y. Yellow is represented by Y.

The photoreceptor 11C, the charging device 12C, the scanning optical device 13C, the developing device 14C, and the discharging device 15C in the image forming section 3 have the same configurations as those of the photoreceptor 11Y, the charging device 12Y, the scanning optical device 13Y, the developing device 14Y, and the discharging device 15Y, respectively, in the image forming section 2.

The photoreceptor 11M, the charging device 12M, the scanning optical device 13M, the developing device 14M, and the discharging device 15M in the image forming section 4 also have the same configurations as the photoreceptor 11Y, the charging device 12Y, the scanning optical device 13Y, the developing device 14Y, and the discharging device 15Y, respectively, in the image forming section 2.

The photoreceptor 11K, the charging device 12K, the scanning optical device 13K, the developing device 14K, and the discharging device 15K in the image forming section 5 also have the same configurations as the photoreceptor 11Y, the charging device 12Y, the scanning optical device 13Y, the developing device 14Y, and the discharging device 15Y, respectively, in the image forming section 2.

In addition, in the case of comprehensively describing the respective parts without distinguishing the toner colors to be used, the member names are simply indicated by the numerals of the reference numerals. For example, the photoreceptors 11Y, 11C, 11M, and 11K are collectively referred to as the photoreceptors 11.

The first transfer belt 6 has a belt conveyor shape. In the present example, the longitudinal direction of the disposed first transfer belt 6 is an up-down direction along the corresponding photoreceptors 11Y to 11K of the image forming sections 2 to 5. The toner images formed on the respective photoreceptors 11 are transferred onto the first transfer belt 6. The toner images are superimposed one on another. The toner image in which the toners of the respective colors are superimposed is transferred onto a sheet supplied from a sheet supply section. The sheet supply and sheet are not shown. The sheet (not illustrated) may be a flat sheet or continuous sheet. This transfer is performed by a second transfer device. The second transfer device is not shown. The second transfer device (not illustrated) is a transfer device. Next, the sheet on which the toner image has been transferred is conveyed to the fixing device 8. The fixing device 8 fixes the toner image onto the sheet. In this way, a color image is formed on the sheet.

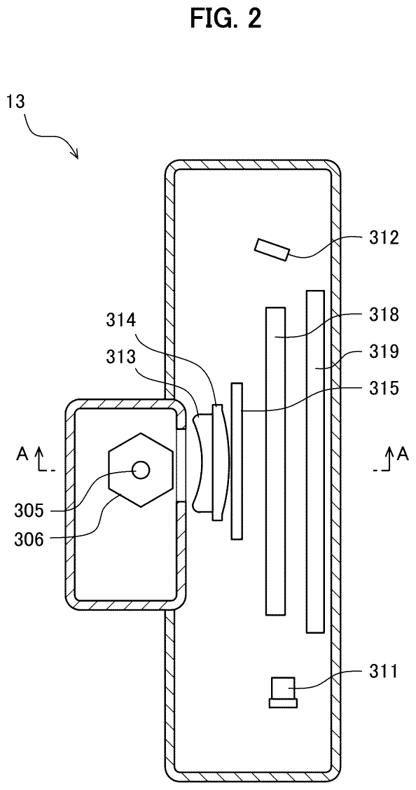

The following is a detailed description of the scanning optical device 13. FIG. 2 is a schematic plan view of the inside of the scanning optical device 13. The scanning optical device 13 according to the present embodiment includes a light source 311 and a predetermined optical system. One of the optical system is a collimator lens. The collimator lens shapes light emitted from the light source 311 into substantially parallel light. The collimator lens is not shown. The scanning optical device 13 includes a light source return mirror 312 and scanning lenses 313 to 315. Furthermore, the scanning optical device 13 includes elongated return mirrors 317 to 319 and scanning lenses 316 and 320. Further, the scanning optical device 13 includes an optical element necessary for the scanning optical device 13. The light source return mirror 312, the scanning lenses 313 to 315, the elongated return mirrors 317 to 319, and the scanning lenses 316 and 320 are included in an optical system.

FIG. 3 is a cross-sectional view of a cutting place taken along a line A-A in FIG. 2. This cross-sectional view illustrates the inside of the scanning optical device. The scanning optical device 13 includes an optical deflector 31 according to the present embodiment inside the scanning optical device 13. The optical deflector 31 includes the housing 32. The housing 32 includes a housing 33 and a casing 34. In FIG. 3, the vertical direction is reversed.

The rotary polygon mirror 306 is supported by the flat plate portion 303 of the casing 34. The rotary polygon mirror 306 has a mirror surface on an outer peripheral surface of the rotary polygon mirror 306. The rotary polygon mirror 306 is a polygon mirror. A magnet 505 is joined to the rotary polygon mirror 306. The magnet 505 is a magnet constituting the driving source 501. The driving source 501 rotationally drives the rotary polygon mirror 306. The driving source 501 is a polygon motor. The substrate 502 is disposed to face the magnet 505. A coil 506 and circuits of a power supply system and a control system are mounted on the substrate 502. The coil 506 constitutes the driving source 501. The circuits of the power source system and the control system drive and control the driving source 501. The circuits of a power supply system and a control system are not illustrated. A rotary shaft of the rotary polygon mirror 306 is a rotary shaft 305. The rotary shaft 305 is supported by the flat plate portion 303. Further, a bearing 504 is provided between the rotary shaft 305 and the rotary polygon mirror 306. The bearing 504 smoothly rotates the rotary polygon mirror 306. Between the housing 33 and the casing 34, transparent flat-plate shaped window glasses 511 and 513 are provided. The window glasses 511 and 513 transmit a reflected light L from the rotary polygon mirror 306. The reflected light Lis eventually applied to the photoreceptors 11. A sealing material 512 is provided between the casing 34 and the substrate 502. The sealing material 512 fills a gap between the members. A heat dissipation member 42 is provided on a surface opposite to the mounting surface of the substrate 502 with a heat transfer member 41 interposed therebetween. The coil 506 is mounted on the mounting surface of the substrate 502. The heat transfer member 41 is a heat transfer sheet. The heat dissipation member 42 is a heat dissipation fin. The heat of the substrate 502 is conducted to the heat dissipation member 42 via the heat transfer member 41. Then, the heat of the substrate 502 is released to the outside of the heat dissipation member 42.

The casing 34 includes a wall portion 509. The wall portion 509 upstands from one side portion of the flat plate portion 303. The casing 34 holds the rotary shaft 305 and the substrate 502. The casing 34, the substrate 502, the window glasses 511 and 513, and the sealing material 512 seal the rotary polygon mirror 306. Due to the sealing, the flow of the air around the rotary polygon mirror 306 is stabilized, and the rotation speed of the rotary polygon mirror 306 is stabilized.

The casing 34 is formed integrally with the housing 33. In comparison with the case where both are separate members, the integral molding realizes a reduction in cost due to a reduction in the number of parts. In addition, the integral molding reduces an assembly position error of each component. Further, by reducing the thickness of the flat plate portion 303 and the wall portion 509, the efficiency of heat radiation to the outside air is improved. Here, the “assembly position error” is as follows. In other words, when the casing 34 and the housing 33 of the optical deflector 31 are separate members, the one with the optical deflector 31 must be attached to the housing 33. A processing error of positioning or a position error of the optical deflector 31 used at that time is an “assembly position error”. A position error of the optical deflector 31 is caused by a slight gap between the fitting holes.

A rotary shaft 305 of the rotary polygon mirror 306 is fixed to the casing 34 with screws. The substrate 502 is held by the housing 32. The material of the substrate 502 is metal or a metal alloy. Preferably, the material of the substrate 502 is iron or an iron alloy. The surface of the substrate 502 is coated with an epoxy resin for preventing electrical conduction. When the material of the substrate 502 is iron or an iron alloy, the rigidity of the substrate 502 is higher than that of a glass epoxy substrate or the like. The substrate 502 is not easily affected by deformation or vibration. When the material of the substrate 502 is iron or an iron alloy, the substrate 502 has high thermal conductivity. Therefore, there is also an advantage that heat is easily dissipated in the substrate 502.

The bearing 504 and the rotary polygon mirror 306 are assembled to the flanged rotary shaft 305. Thus, they can be attached to the casing 34 without adjustment of their rotation performance or disassembly after measurement.

The sealing material 512 is applied to the substrate 502. The sealing material 512 may be applied to the casing 34. However, a curing time of the sealing material 512 is required after the application. Therefore, in a case where the casing 34 is integrally molded with the housing 33 and the integrally molded one is relatively large, it is better to apply it to the substrate 502. That is, it is possible to reduce an occupied space while waiting for the curing of the sealing material 512, and the application of the sealing material 512 to the substrate 502 is advantageous in a production process.

For example, the heat transfer member 41 is an elastic member made of resin, and the thickness of the heat transfer member 41 is constant. Because of the constant thickness, the heat transfer member 41 is processed by linear cutting of a base material sheet or punching with a simple die at the time of manufacturing the heat transfer member 41. In this way, manufacturing costs are reduced.

In the shape of the heat dissipation member 42, a plurality of thin ribs stand on a flat plate. This is manufactured by aluminum die-casting, or extrusion molding using an extrusion die and cutting work. In the housing of the image forming apparatus 1, the heat dissipation member 42 is configured such that outside air is blown to the heat dissipation member 42 by a fan or an air duct. Thus, the substrate 502 and the like are efficiently cooled. A fan and a blowing duct are not illustrated.

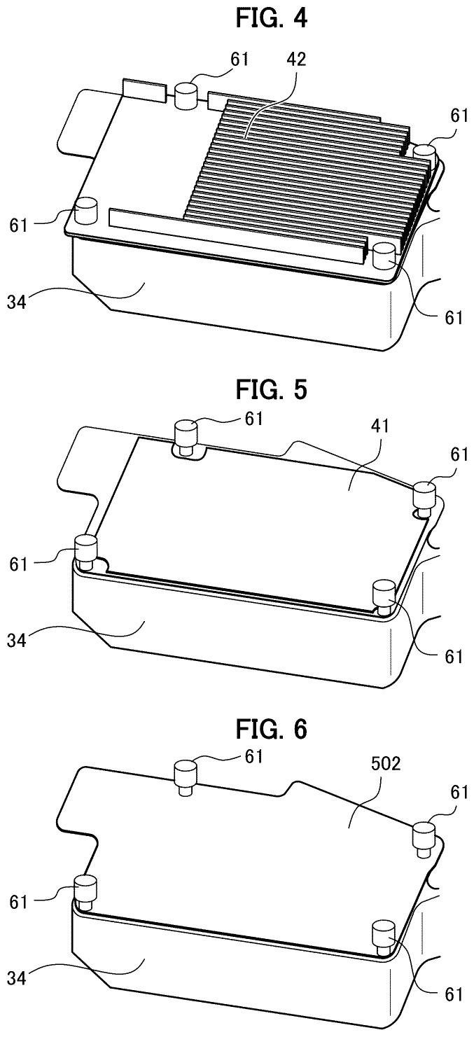

FIGS. 4 to 8 are perspective views of the periphery of the optical deflector on the back surface of the scanning optical device. As shown in FIG. 4, the bottom of the casing 34 is the heat dissipation member 42. As shown in FIG. 5, the heat transfer member 41 is positioned directly above the heat dissipation member 42. As shown in FIG. 6, the substrate 502 is positioned directly above the heat dissipation member 42. The heat dissipation member 42 and the substrate 502 are screwed and fixed to the casing 34 at a plurality of places with screws 61 that are fixing members. In this example, the heat dissipation member 42 and the substrate 502 are screwed and fixed to the casing 34 at four positions. The heat transfer member 41 is sandwiched and fixed between the heat dissipation member 42 and the substrate 502.

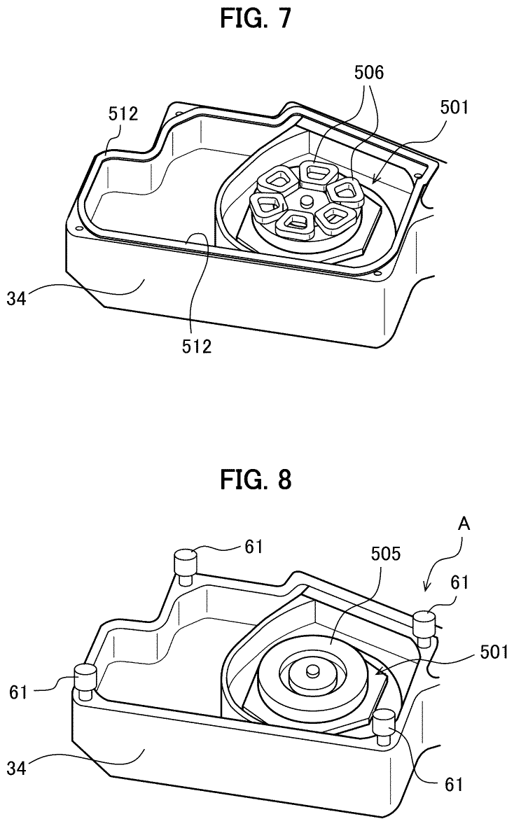

As shown in FIG. 7, the coil 506 of the driving source 501 is disposed directly above the substrate 502. The sealing material 512 is formed on the edge of the casing 34. An edge of the casing 34 encircles the coil 506. As shown in FIG. 8, in addition to the magnet 505 of the driving source 501, a rotor and a yoke are provided above the coil 506.

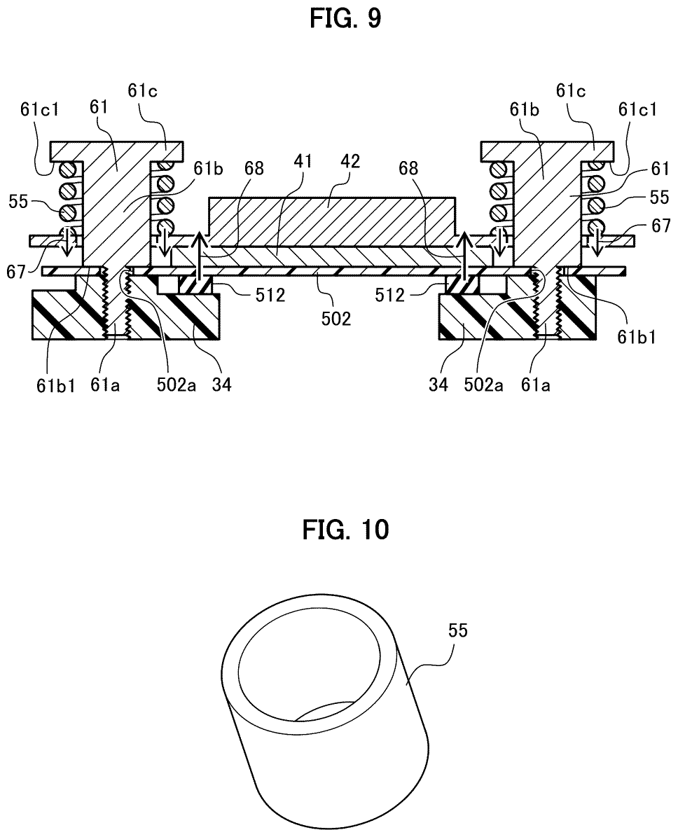

FIG. 9 is a conceptual vertical cross-sectional view of the structure illustrated in FIGS. 4 to 8. The screws 61 are stepped screws. The screws 61 have threaded portions 61a. An outer periphery of each of the threaded portions 61a is threaded. The screws 61 have head portions 61b. The head portions 61b extend from end portions 61b1. Each of the head portions 61b has a larger diameter than each of the threaded portions 61a. Each of brims 61c is formed at a base end part of each of the head portions 61b. Each of the brims 61c has a larger diameter than each of the head portions 61b.

The threaded portions 61a are screwed and fixed in screw holes 34a of the casing 34. Thus, in the substrate 502, the threaded portions 61a are inserted through holes 502a. The holes 502a extend through the substrate 502. The head portions 61b of the end portions 61b1 and the casing 34 sandwich and fix the substrate 502. A sealing material 512 is interposed between the casing 34 and the substrate 502. The interposed sealing material 512 is compressed by being pressed by both of the members.

Elastic members 55 are interposed between lower surfaces 61cl of the brims 61c and an end portion of the heat dissipation member 42. For example, the elastic members 55 are compressed coil springs, and the head portions 61b are inserted through the elastic members 55. The elastic members 55 are compressed by the lower surfaces 61cl of the brims 61c. The elastic members 55 biases the heat dissipation member 42 toward the substrate 502, thereby supporting and fixing the heat dissipation member 42. The heat transfer member 41 is sandwiched between the heat dissipation member 42 and the substrate 502. Thus, the heat transfer member 41 is also supported and fixed to the substrate 502.

For example, the substrate 502 is firmly pressed and fixed to the casing 34 by the threaded portions 61a of the screws 61. For example, the strength of each of the screws 61 is about 500 N. The force F is calculated by “Tightening Torque T 0.2 [N·m]=Constant k 0.2×Nominal Diameter 0.002 [m]×Axial Force F [N]”. The reference is https://d-engineer.com/kikaiyouso/toruq.html.

In FIG. 9, the rotary polygon mirror 306 and the coil 506 are not illustrated. As described above with reference to FIG. 3, the rotary polygon mirror 306, the coil 506, and the casing 34 are provided in the same direction from the substrate 502. The heat dissipation member 42 is provided opposite to the casing 34 with respect to the substrate 502. The heat transfer member 41 is provided between the substrate 502 and the heat dissipation member 42. The heat dissipation member 42 is pressed and held toward the substrate 502 with a biasing force by the brims 61c of the screws 61 and the elastic members 55. This biasing force is weaker than the fixing force of the substrate 502. The fixing force is a force with which the head portions 61b presses the substrate 502. For example, the biasing force is about 10 N per each of the elastic members 55.

In this way, the heat dissipation member 42 is pressed by the elastic members 55. This force is weaker than a fixing force of the screws 61, and the screws 61 are screwed and fixed to the substrate 502. This fixing force is a force that presses the substrate 502 with the end portions 61b1 of the head portions 61b. Thus, a reaction force of the heat transfer member 41 decreases. Therefore, deformation of the substrate 502 is prevented. Therefore, the possibility that the predetermined driving force is not generated and the rotation of the polygon motor is hindered is reduced. The polygon motor is the driving source 501. A possibility of hindrance to the movement of the driving source 501 of the rotary polygon mirror 306 is reduced.

The elastic members 55 are pressed by screws 61 serving as fixing members. Therefore, the elastic members 55 generates the biasing force as described above. Therefore, fixing of the substrate 502 and holding of the heat dissipation member 42 are performed at the same time. Thus, as compared with a case where fixing of the substrate 502 and holding of the heat dissipation member 42 are performed by separate components, a reduction in working time and a reduction in the number of components at the time of manufacture are performed.

The elastic members 55, which are compressed coil springs or the like, are wound around screws 61 serving as fixing members. Therefore, it is easy to collectively attach the elastic members 55 and the screws 61, and workability at the time of manufacturing is improved. In addition, space saving of the arrangement place of the elastic members 55 is achieved.

For example, as the elastic members 55, hollow cylindrical elastic components are used instead of the compressed coil springs. For example, each of the hollow cylindrical elastic components is resin, iron, or the like that is about 0.5 mm thick, and the shape of each of the hollow cylindrical elastic component is a cylindrical shape as illustrated in FIG. 10. As described above, compressed coil springs are also used as the elastic members 55. In such a case, the spring constant decreases. Therefore, the elastic members 55, which are compressed coil springs or the like, are less likely to be influenced by component tolerance. The spring constant is obtained by dividing force by displacement.

As described above, the screws 61 are used as the fixing members. Thus, as compared with means such as caulking and fixing or adhesion and fixing, attachment and detachment of the fixing members are easy, and a strong fixing force is obtained with a small fastening force. The screws 61 are stepped screws.

The elastic members 55 are disposed opposite to the casing 34 of the housing 32 with respect to the substrate 502. Therefore, the lifting of the casing 34 from the seat surface of the substrate 502 is small at the time of attaching the elastic members 55 to the substrate 502, the heat transfer member 41, and the heat dissipation member 42. Therefore, attachment of the elastic members 55 is facilitated.

As shown in FIG. 3, the substrate 502 does not directly support the rotary polygon mirror 306. As shown in FIG. 3, the substrate 502 is positioned away from the rotary polygon mirror 306. Therefore, if the substrate 502 is deformed, a change in the distance between the magnet 505 and the coil 506 on the substrate 502 tends to be large. However, as described above, deformation of the substrate 502 is prevented in the present embodiment, and therefore, the effect of preventing deformation is more significantly obtained. Thus, the change in the distance between the coil 506 and the magnet 505 is unlikely to be large.

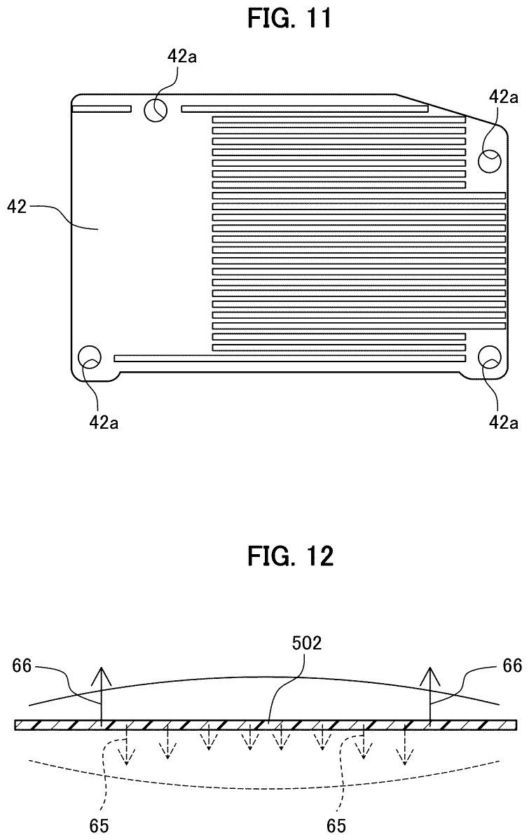

The screws 61 pass through holes 42a in FIG. 11. For example, the difference between the outer diameter of each of the screws 61 and the diameter of each of the holes 42a of the heat dissipation member 42 is 1 mm. There is a slight gap between these two. Thus, the optical deflector 31 can regulate the position of the heat dissipation member 42 in the width direction. This regulation is light to some extent. Thus, when the heat dissipation member 42 is attached, the heat dissipation member 42 is held without significant displacement of the position of the heat dissipation member 42. Thus, the workability of attaching the heat dissipation member 42 is excellent. Even when the heat dissipation member 42 is pressed by the weak force of the elastic members 55 as described above, the deformation of the heat transfer member 41 due to creep deformation is prevented. Thus, the occurrence of the horizontal misregistration of the heat dissipation member 42 due to instantaneous lifting of the heat dissipation member 42 caused by an impact is prevented.

In FIG. 12, a force applied to the substrate and deformation of the substrate are described. The sealing material 512 between the casing 34 and the substrate 502 further prevents deformation of the substrate 502. The description is as follows. For this description, reference is made to FIG. 9 and FIG. 12. As described above, even when the substrate 502 is pressed by a weak force of the elastic members 55, a force capable of deforming the substrate 502 is generated. The weak force of the elastic members 55 is indicated by a downward arrow 67 in FIG. 9. A force that can deform the substrate 502 is generated by the reaction force of the heat transfer member 41. This force is represented by a downward arrow 65 in FIG. 12. The thickness of the sealing material 512 is greater than the size of the gap between the substrate 502 and the casing 34 before the sealing material 512 is attached to the substrate 502. Therefore, when the sealing material 512 is crushed in attachment of the sealing material 512 to the substrate 502, a reaction force is generated. The reaction force is indicated by an upward arrow 68 in FIG. 9 and an upward arrow 66 in FIG. 12. A force to be applied to the substrate 502 is generated in a direction opposite to a direction in which the substrate 502 is deformed by the reaction force of the heat transfer member 41. Thus, deformation of the substrate 502 is prevented.

The sealing material 512 is formed of an elastic body. When the sealing material 512 is not sandwiched between the substrate 502 and the casing 34 of the housing 32, the thickness of the sealing material 512 is greater than the gap distance between the substrate 502 and the casing 34. The gap between the substrate 502 and the casing 34 is reliably filled with the sealing material 512. Thus, rotation can be stabilized, the optical deflector 31 can be stably protected from dust, and deformation of the substrate 502 can be prevented.

As illustrated in FIG. 7, the sealing material 512 surrounds the entire periphery of the driving source 501 on the substrate 502. Therefore, as compared with the case where the sealing material 512 is interrupted in the middle, it is possible to effectively stabilize the rotation, make the optical deflector 31 dustproof, and prevents the deformation of the substrate 502.

The screws 61 are fixing members, and the screws 61 fix the substrate 502. As illustrated in FIG. 9, at least one of the screws 61 is located outward from the sealing material 512. Thus, the reaction force of the sealing material 512 becomes as illustrated in FIG. 12 as described above. Thus, due to the reaction force of the heat transfer member 41, a force in a direction opposite to the direction of the force deforming the substrate 502 is applied to the substrate 502. Therefore, the substrate 502 is unlikely to be distorted.

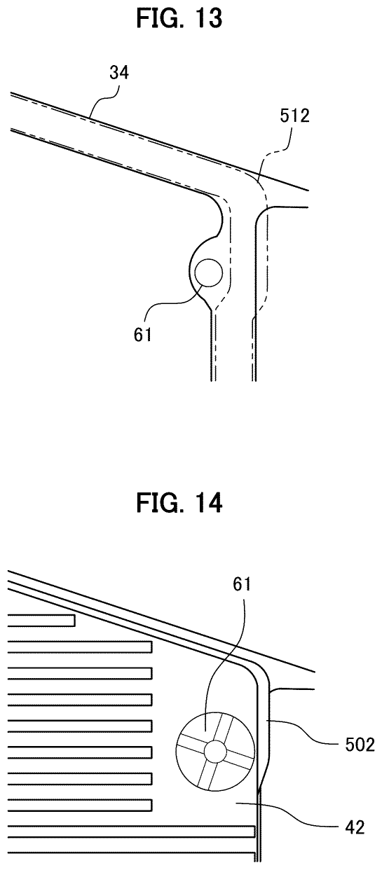

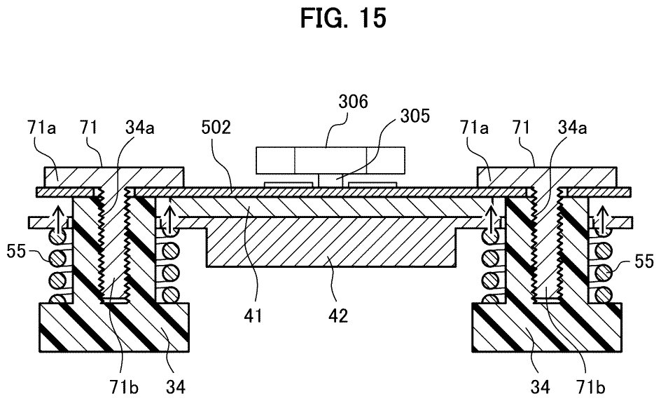

In a portion indicated by an arrow A in FIG. 8, a portion of the sealing material 512 is located outward from the screws 61 as the fixing members. This positional relationship is illustrated in FIGS. 13 and 14. In FIG. 14, the shape of the substrate 502 is protruded slightly to the right. The casing 34 has a receiving surface for the sealing material 512. As illustrated in FIG. 14, the receiving surface does not protrude to the right, and a part of the receiving surface is biased toward the left with respect to the sealing material 512. This also serves as a portion into which a tool is inserted when the substrate 502 is removed. As described above, in FIG. 14, the casing 34 is slightly shifted to the left relative to the outer shape of the sealing material 512. Therefore, the sealing material 512 has a portion which is sandwiched and crushed between the casing 34 and the substrate 502. However, a width of the crushed portion is narrower than a width of another portion. Therefore, the reaction force of the sealing material 512 is smaller in the portion that does not abut on the casing 34 than the reaction force in another portion. Here, when the reaction force of the sealing material 512 is generated outside the screws 61, a force in a direction promoting the deformation of the substrate 502 due to the reaction force of the heat transfer member 41 may be generated. However, in the present embodiment, the force that encourages deformation of the substrate 502 is reduced by reducing the reaction force of the sealing material 512 at that place. Thus, this prevents deformation of the substrate 502.

The operation of affixing the heat transfer member 41 and the heat dissipation member 42 to the substrate 502 may be performed before the substrate 502 is placed on the casing 34 or may be performed after the substrate 502 is placed on the casing 34. If air bubbles enter between the heat transfer member 41 and the substrate 502 or between the heat transfer member 41 and the heat dissipation member 42, the efficiency of heat conduction from the substrate 502 to the heat dissipation member 42 deteriorates. Therefore, it is desirable to expel the air bubbles by pressing these members with a roller or the like. Alternatively, it is desirable to perform a step of collapsing air bubbles. It is desirable to provide the surfaces of the heat transfer member 41 and the heat dissipation member 42 with adhesiveness with an adhesive or the like. Thus, a member is less likely to slip down during work. Therefore, workability is improved.

FIG. 15 shows a modification example of the above embodiment. FIG. 15 corresponds to FIG. 9. In the embodiment, the elastic members 55 is present opposite to the casing 34 with respect to the substrate 502. Further, as shown in FIG. 3, the rotary polygon mirror 306 and the rotary shaft 305 are positioned away from the substrate 502 held by the casing 34. However, as shown in FIG. 15, elastic members 55 may be disposed in the same direction as a casing 34 with respect to a substrate 502. A rotary polygon mirror 306 and a rotary shaft 305 may be fixed to the substrate 502.

In the configuration of the modification example, screw holes 34a are opened in fixed portions 34b. The fixed portions 34b are formed in the casing 34. Each of the fixed portions 34b has a cylindrical shape. The screw holes 34a are for fixing the substrate 502. The substrate 502 is firmly fixed to the casing 34 with screws 71. The screws 71 have only screw heads 71a and threaded portions 71b. The screw heads 71a are not stepped. Above the substrate 502, a coil 506 of a driving source 501 and the rotary shaft 305 of the rotary polygon mirror 306 are provided. The driving source 501 rotationally drives the rotary polygon mirror 306. The upper part of the substrate 502 is located opposite the casing 34. In FIG. 15, the driving source 501 and the coil 506 are not illustrated. The casing 34, a heat transfer member 41, and a heat dissipation member 42 are attached to a lower portion of the substrate 502. The fixed portions 34b are formed in the casing 34. Each of the fixed portions 34b has a cylindrical shape. The elastic members 55 are compressed coil springs or the like. The elastic members 55 are fixed around the fixed portions 34b while being compressed. The elastic members 55 press the heat dissipation member 42 with a force which is weaker than the fixing force of the screws 61. The elastic members 55 hold the heat transfer member 41 and the heat dissipation member 42 with respect to the substrate 502. In the present modification example, since standard screws 71 can be used, the manufacturing cost of an optical deflector 31 can be reduced. These standard screws 71 have only screw heads 71a and threaded portions 71b. The screw heads 71a are not stepped.

### Example

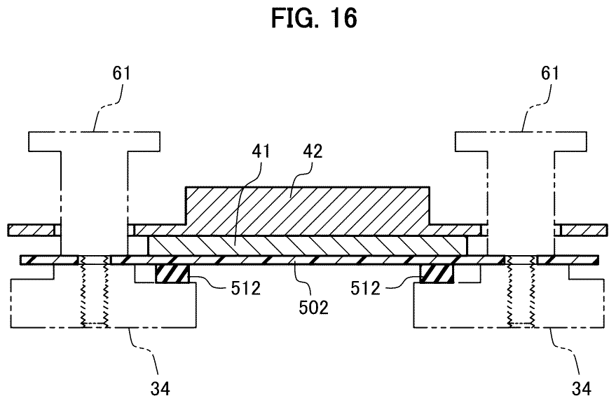

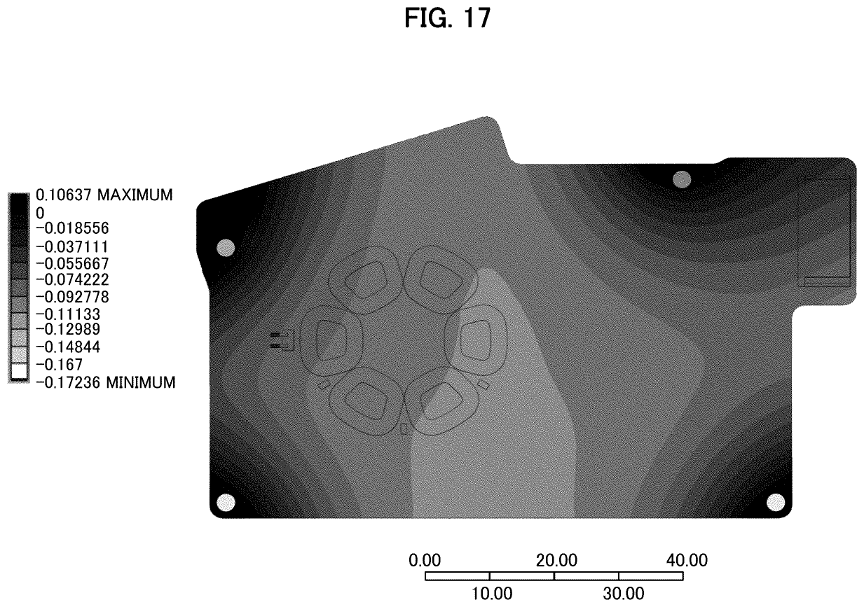

The present inventors conducted the following simulation in order to confirm an effect of the present invention. That is, a structural analysis was performed by using “ANSYS 2023 R1 Mechanical”. “ANSYS” is a trademark. The simulation model is illustrated in FIG. 16. Contour diagrams of the simulation results are illustrated in FIGS. 17 to 19. In this simulation, the screws 61 were omitted. The screws 61 are stepped screws. In the present example, displacement due to the pressing of the screws 61 and the compressive force of the elastic members 55 were expressed by applying the voltages to the heat dissipation member 42. The casing 34 was omitted. There are portions to be pressed by the brims 61c of the screws 61. By fixing these portions in the simulation, the fixation of the substrate 502 was expressed. In FIG. 16, the above-described omitted members are indicated by imaginary lines. The substrate 502 was formed of iron. The heat dissipation member 42 was formed of aluminum. The Young's modulus of the heat transfer member 41 is 3 MPa. The heat transfer member 41 was 1 mm thick. The Young's modulus of the sealing material 512 was 1 MPa. The sealing material 512 was 0.5 mm thick.

As a result of such a simulation, the maximum value of the deformation amount of the substrate 502 is as follows.

(1) In the case of the conventional configuration, the heat dissipation member 42 is strongly pressed by the screws 61, and the sealing material 512 is not provided. In this case, the maximum value of the amount of deformation of the substrate 502 was 0.17 mm as shown in FIG. 17. The conventional configuration is a comparative example.

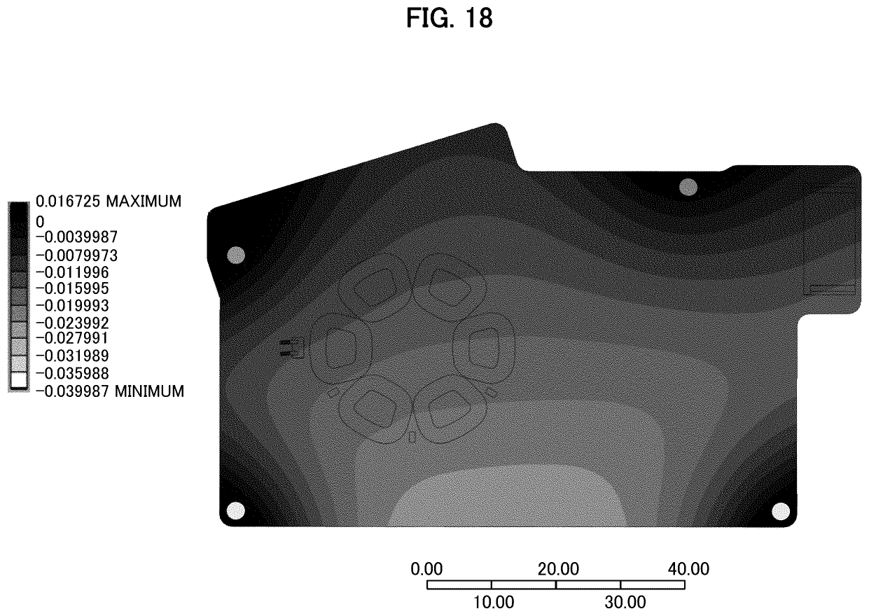

(2) In the case of the configuration of Example 1 of the present application, the heat dissipation member 42 was weakly pressed by the elastic members 55, and the sealing material 512 was not provided. In this case, the maximum value of the amount of deformation of the substrate 502 was 0.04 mm as shown in FIG. 18.

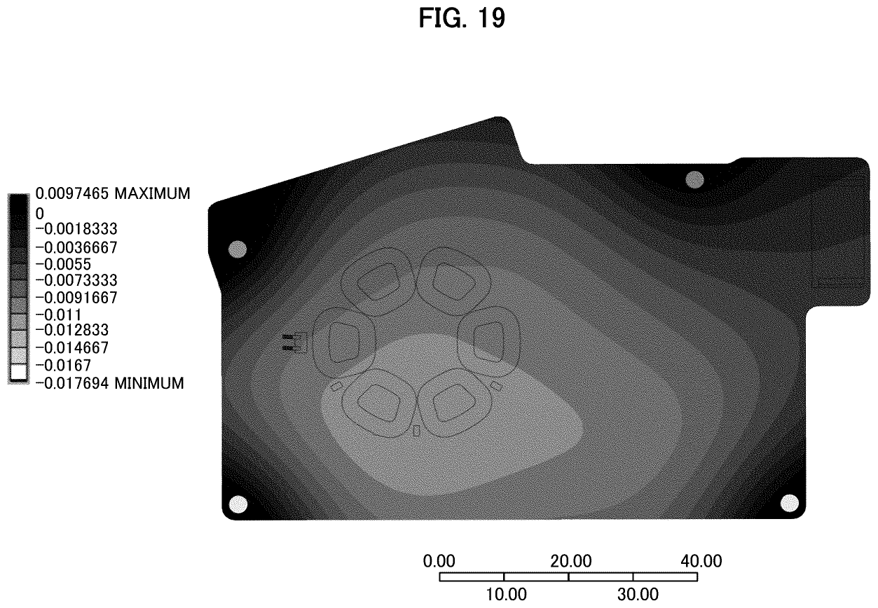

(3) In the case of the configuration of Example 2 of the present application, the heat dissipation member 42 was weakly pressed by the elastic members 55, and the sealing material 512 was present. In this case, the maximum value of the amount of deformation of the substrate 502 was 0.02 mm as shown in FIG. 19.

(4) In the simulation results, the maximum value of the deformation amount of the substrate 502 was significantly reduced in the case of the examples of the present invention of the above bracket 2 and the above bracket 3 as compared with the case of the comparative example of the above bracket 1. Therefore, the effects of the present invention were confirmed by the present examples 1 and 2.

Note that the analysis conditions in the above examples are as described in the following brackets 1 to 3. These numbers correspond to the above-described brackets 1 to 3, respectively.

(1) The heat dissipation member 42 was strongly pressed by the screws 61, and the sealing material 512 was not provided. In the heat dissipation member 42, the displacements at the four pressing points of the screws 61 were respectively 0.2 mm. It is assumed that the heat transfer member 41 of 1 mm thick is compressed until it abuts against a spacer of 0.8 mm thick.

(2) The heat dissipation member 42 was weakly pressed by the elastic members 55, and the sealing material 512 was not provided. In the heat dissipation member 42, the pressing points of the elastic members 55 were applied with forces of each 10 N by four screws 61.

(3) The heat dissipation member 42 was weakly pressed by the elastic members 55, and the sealing material 512 was present. Similar to the bracket 2, the sealing material 512 was added to the simulation.

Although embodiments of the present invention have been described and illustrated in detail, the disclosed embodiments are made for purposes of illustration and example only and not limitation. The scope of the present invention should be interpreted by terms of the appended claims.

What is claimed is:

1. An optical deflector comprising:
a housing;
a rotary polygon mirror housed in the housing and having a mirror surface formed on an outer peripheral surface of the rotary polygon mirror;
a substrate on which at least a part of a driving source configured to drive the rotary polygon mirror is mounted;
a heat dissipation member configured to dissipate heat of the substrate to the outside of the substrate;
a heat transfer member which includes an elastic body, is interposed between the substrate and the heat dissipation member, and is configured to transfer heat of the substrate to the heat dissipation member;
fixing members that fix the substrate to the housing; and
elastic members which elastically press the heat dissipation member and the heat transfer member against the substrate with a biasing force such that the heat dissipation member and the heat transfer member are supported by the substrate, and wherein
the biasing force is weaker than a fixing force of the fixing members.

2. The optical deflector according to claim 1, wherein
the elastic members generate the biasing force by being pressed by the fixing members.

3. The optical deflector according to claim 2, wherein
the elastic members are wound around the fixing members.

4. The optical deflector according to claim 1, wherein
the elastic members are compressed coil springs.

5. The optical deflector according to claim 1, wherein
the fixing members are screws.

6. The optical deflector according to claim 1, wherein
the fixing members restrict a position of the heat dissipation member in a width direction of the heat dissipation member.

7. The optical deflector according to claim 1, wherein
a sealing material is interposed between the substrate and the housing.

8. The optical deflector according to claim 7, wherein
the sealing material surrounds a circumference of the driving source.

9. The optical deflector according to claim 7, wherein
the sealing material includes an elastic body, and
the sealing material is thicker than a gap between the substrate and the housing when the sealing material is not sandwiched between the substrate and the housing.

10. The optical deflector according to claim 7, wherein
at least one of the fixing members is located outward from the sealing material.

11. The optical deflector according to claim 7, wherein
the sealing material includes a part located outward from the fixing members,
the part includes a portion sandwiched between the housing and the substrate, and
a width of the portion is narrower than a width of another portion.

12. The optical deflector according to claim 1, wherein
the elastic member is disposed opposite to the housing with respect to the substrate.

13. The optical deflector according to claim 1, wherein
the substrate does not directly support the rotary polygon mirror and is positioned away from the rotary polygon mirror.

14. The optical deflector according to claim 1,
wherein the substrate includes iron or an alloy containing iron.

15. The optical deflector according to claim 1,
wherein the heat transfer member has a constant thickness.

16. A scanning optical device comprising:
the optical deflector according to claim 1;
a light source; and
an optical system configured to perform at least one of irradiating the rotary polygon mirror with light to be emitted from the light source and irradiating a predetermined destination with light to be reflected by the rotary polygon mirror.

17. An image forming apparatus comprising:
a photoreceptor;
the scanning optical device according to claim 16, which is configured to form an electrostatic latent image by exposing the photoreceptor; and
a developing device configured to develop the electrostatic latent image on the photoreceptor with toner.
